(19) United States
(12) Patent Application Publication
(10) Pub. No.: US 2006/0023757 A1
(43) Pub. Date: Feb. 2, 2006

(54) Apparatus, system, and method for wavelength conversion of mode-locked extended cavity surface emitting semiconductor lasers

(76) Inventors: Aram Mooradian, Kentfield, CA (US); Andrei V. Shchegrov, Campbell, CA (US); Jason P. Watson, San Jose, CA (US)

Correspondence Address: COOLEY GODWARD, LLP, 3000 EL CAMINO REAL, 5 PALO ALTO SQUARE, PALO ALTO, CA, 94306, US

(21) Appl. No.: 11/194,141

(22) Filed: Jul. 29, 2005

Related U.S. Application Data
(60) Provisional application No. 60/592,890, filed on Jul. 30, 2004.
(60) Provisional application No. 60/667,201, filed on Mar. 30, 2005.
(60) Provisional application No. 60/667,202, filed on Mar. 30, 2005.
(60) Provisional application No. 60/666,826, filed on Mar. 30, 2005.
(60) Provisional application No. 60/646,072, filed on Jan. 21, 2005.
(60) Provisional application No. 60/689,582, filed on Jun. 10, 2005.

(51) Int. Cl. H01S 3/098

(52) U.S. Cl. 372/18; 372/25

(57) ABSTRACT

A mode-locked laser with intracavity frequency conversion is disclosed. In one embodiment the conversion frequency is improved by reducing the temporal, spatial, or polarization overlap between pulses at the fundamental frequency and pulses at a frequency-shifted frequency.

### CROSS-REFERENCE TO RELATED APPLICATIONS

This application claims the benefit of provisional application 60/592,890, filed on Jul. 30, 2004; 60/667,201 filed on Mar. 30, 2005; 60/667,202 filed on Mar. 30, 2005; 60/666,826 filed on Mar. 30, 2005; 60/646,072 filed on Jan. 21, 2005; and 60/689,582 filed on Jun. 10, 2005, the contents of each of which are hereby incorporated by reference.

This application is also related to copending application attorney docket No. NOVX-004/01, “Projection Display Apparatus, System, and Method,” filed on the same day as the present application, the contents of which are hereby incorporated by reference.

### FIELD OF THE INVENTION

The present invention is generally related to frequency-doubled mode-locked lasers. More particularly, the present invention is directed towards frequency-doubled mode-locked extended cavity surface-emitting semiconductor lasers.

### BACKGROUND OF THE INVENTION

Mode-locked lasers are of interest for a variety of applications due to the capability of mode-locked lasers to generate optical pulses having a high peak power. A mode-locked laser typically utilizes either an active modulator or a passive, saturable optical absorber within the optical resonator to force the laser to generate short pulses having a periodicity corresponding to the round-trip transit time in the laser resonator. In a mode-locked laser with an active modulator the optical loss of the active modulator is periodically varied to force the mode-locked laser to generate short pulses. In a mode-locked laser with a saturable absorber, a saturable absorber in the optical resonator has an optical loss that saturates with increasing optical intensity. The saturable optical loss is chosen such that the generation of a train of short pulses is favored. A mode-locked laser has many resonant modes that are coupled in phase. Thus, in addition to other properties, a mode-locked laser is also spectrally broadened compared with a continuous wave (cw) laser.

The output of a mode-locked laser may be frequency doubled. FIG. 1 illustrates a prior art mode-locked laser configuration. A laser cavity having mirrors 105 and 110 includes optical gain 115. A saturable absorber 120 is provided to create mode-locking. The mode-locked pulsed output of the laser cavity are input to a nonlinear frequency doubling crystal 125, such as a crystal designed to generate an output pulse at twice the fundamental input frequency, what is often known as the “second harmonic frequency.” Note that this configuration is a single-pass configuration in which each input pulse of light 130 at a fundamental frequency makes only one pass through the nonlinear frequency doubling crystal 125 to generate a corresponding frequency doubled pulse 135.

One type of laser of interest for mode-locking is an extended cavity semiconductor laser. FIG. 2 illustrates an exemplary prior art extended cavity surface emitting laser 200. Extended cavity surface-emitting semiconductor lasers are a class of semiconductor lasers that have a number of advantages over edge emitting semiconductor lasers or conventional surface emitting lasers. Extended cavity surface emitting lasers typically include at least one reflector disposed within a semiconductor gain element. For example, an intra-cavity stack of Bragg mirrors 205 (also known as a distributed Bragg reflector or a DBR) grown on either side of a quantum well gain region 210 form a Fabry-Perot resonator to define the operating wavelength of the fundamental laser wavelength. An additional external reflector 215 spaced apart from the semiconductor gain element defines an extended cavity of an optical resonator, providing additional wavelength control and stability. By appropriate selection of the quantum well gain region 210, Bragg mirrors 205, and external reflector 215 a fundamental wavelength can be selected within a large range of wavelengths. The fundamental wavelength, in turn, may then be frequency doubled by including an intra-cavity frequency doubling optical crystal 220 to generate light at a desired color.

Extended cavity surface-emitting semiconductor lasers developed by the Novalux Corporation of Sunnyvale, Calif. have demonstrated high optical power output, long operating lifetimes, accurate control of laser wavelength, control of spatial optical mode, provide the benefit of surface emission for convenient manufacturing and testing, and may be adapted to include optical frequency conversion elements, such as second harmonic frequency doublers, to generate light at the red, green, and blue colors. Background information describing individual extended cavity surface emitting semiconductor lasers and frequency-doubled surface emitting lasers developed by the Novalux Corporation are described in U.S. Pat. Nos. 6,243,407, 6,404,797, 6,614,827, 6,778,582, and 6,898,225, the contents of each of which are hereby incorporated by reference. Other details of extended cavity surface emitting lasers are described in U.S. patent application Ser. Nos. 10/745,342 and 10/734,553, the contents of which are hereby incorporated by reference.

FIG. 3 illustrates some of the problems associated with modifying an extended cavity surface emitting laser having intra-cavity frequency doubling to function as a mode-locked laser. There are three basic problems with such a configuration. First, a mode-locking modulator 225 must be placed within the extended cavity, increasing the cost of the laser. Second, mode-locking modulator 225 will tend to cause insertion loss for the second harmonic frequency. Third, there is a problem with interference of optical pulses inside of the frequency doubling crystal. For example, suppose at some initial time that mode-locking begins. If a first optical pulse at the fundamental frequency enters the frequency doubling crystal at one crystal facet it will generate a frequency doubled counterpart pulse that propagates in time phase with it out the second facet. Thus, an optical pulse at the fundamental frequency -(with slightly reduced power level) and an optical pulse at the second harmonic frequency will emerge from the other facet of frequency doubling crystal 220. Through a subsequent reflection, such as from the external mirror, both of these optical pulses will be reflected back to the frequency-doubling crystal. Thus, pulses at both the fundamental and the second harmonic frequency will re-enter the frequency doubling crystal. Frequency doubling crystals rely upon nonlinear optical effects that strongly depend upon the electric field strength and proper phasing. The reflected second harmonic pulse can create interference and de-phasing effects which reduce the efficiency with which the optical pulse at the harmonic frequency can generate additional light at the second harmonic frequency.

In light of the above-described problems, the apparatus, method, and system of the present invention was developed.

### SUMMARY OF THE INVENTION

An apparatus, system, and method is disclosed in which mode-locked optical pulses are frequency-converted using an intra-cavity frequency conversion. An element is included to reduce the temporal, spatial, or polarization overlap of frequency-shifted pulses with respect to pulses at the fundamental frequency in order to reduce deleterious interference in a nonlinear optical material.

One embodiment of a mode-locked laser comprises: an optical resonator; a laser gain element disposed in the optical resonator for providing optical gain about a fundamental laser frequency; a mode-locking modulator disposed in the optical resonator; a nonlinear optical material disposed in the optical resonator for performing optical frequency conversion in which an input pulse at the fundamental laser frequency is converted into an output pulse of reduced power at the fundamental laser frequency and an output optical pulse at a harmonic frequency; and an element disposed in the optical resonator configured to at least partially reduce the spatial, temporal, or polarization overlap of output optical pulses at the harmonic frequency with optical pulses at the harmonic frequency whereby interference between optical pulses at the harmonic frequency and the fundamental frequency in the nonlinear optical material are reduced.

One embodiment of a method of operating a mode-locked laser comprises: providing a nonlinear optical material within an optical resonator for frequency conversion of optical pulses at a fundamental frequency; generating mode-locked laser pulses at the fundamental frequency within the optical resonator; in a first pass through the nonlinear optical material, generating an optical pulse at a harmonic frequency to form a first pulse at a harmonic frequency and a second optical pulse at said fundamental frequency; and at least partially reducing a temporal, spatial, or polarization overlap of the first pulse and the second pulse prior to coupling the first pulse and the second pulse back to the nonlinear optical material, whereby interference effects are reduced in the nonlinear optical material.

### BRIEF DESCRIPTION OF THE FIGURES

The invention is more fully appreciated in connection with the following detailed description taken in conjunction with the accompanying drawings, in which:

FIG. 1 illustrates a prior art mode-locked laser;

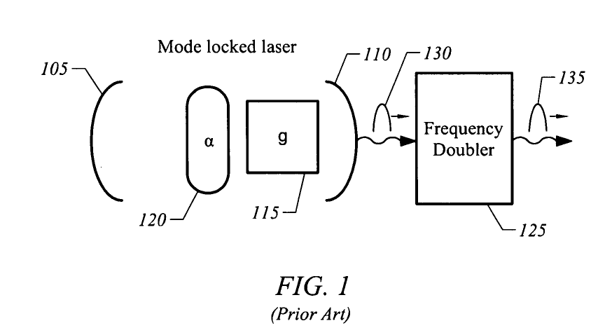

FIG. 2 illustrates a prior art extended cavity surface emitting laser;

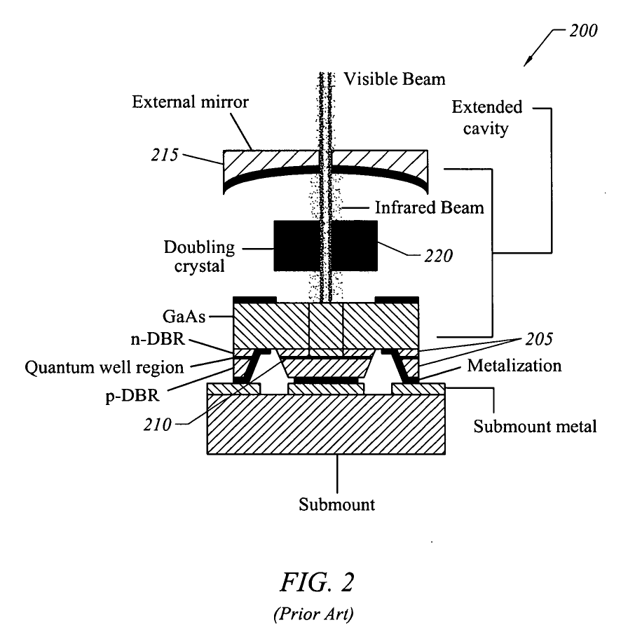

FIG. 3 illustrates some of the problems associated with modifying prior art extended cavity surface emitting lasers to generate mode-locked pulses;

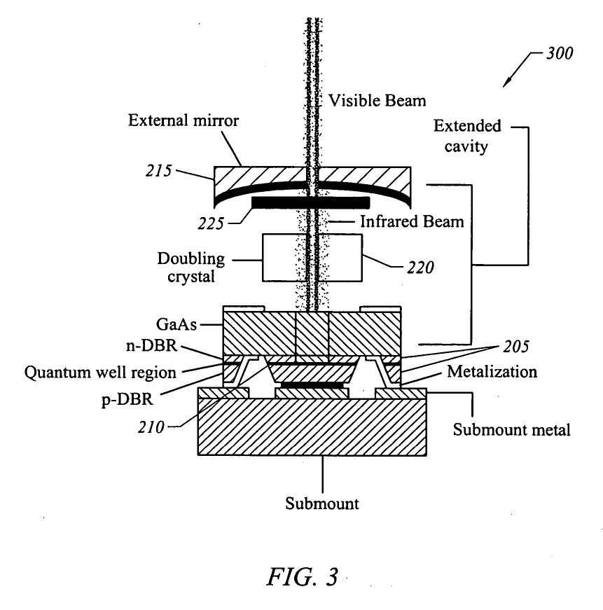

FIG. 4 is a block diagram of a mode-locked laser in accordance with one embodiment of the present invention;

FIG. 5 is a block diagram illustrating a technique for introducing a time delay between harmonic and fundamental pulses in accordance with one embodiment of the present invention;

FIG. 6 is a block diagram illustrating integration of a mode-locking modulator with a time delay element in accordance with one embodiment of the present invention;

FIG. 7 is a block diagram illustrating integration of a time delay element and a gain element in accordance with one embodiment of the present invention;

FIG. 8 illustrates a mode-locked laser in accordance with one embodiment of the present invention;

FIG. 9 illustrates a semiconductor element integrating a mode-locking modulator and time delay element in accordance with one embodiment of the present invention;

FIG. 10 illustrates exemplary pulses and their time delay in accordance with one embodiment of the present invention;

FIG. 11 illustrates a semiconductor structure integrating a gain element, reflector, mode-locking modulator, and time delay element;

FIG. 12 illustrates a semiconductor structure integrating a gain element and a lens selected such that reflected light at a harmonic frequency is spread apart from emergent light at a fundamental frequency;

FIG. 13 is a block diagram illustrating a technique for introducing a difference in polarization between harmonic and fundamental pulses in accordance with one embodiment of the present invention; and

FIG. 14 is a block diagram illustrating a technique for introducing a difference in polarization between harmonic and fundamental pulses in accordance with one embodiment of the present invention.

Like reference numerals refer to corresponding parts throughout the several views of the drawings.

### DETAILED DESCRIPTION OF THE INVENTION

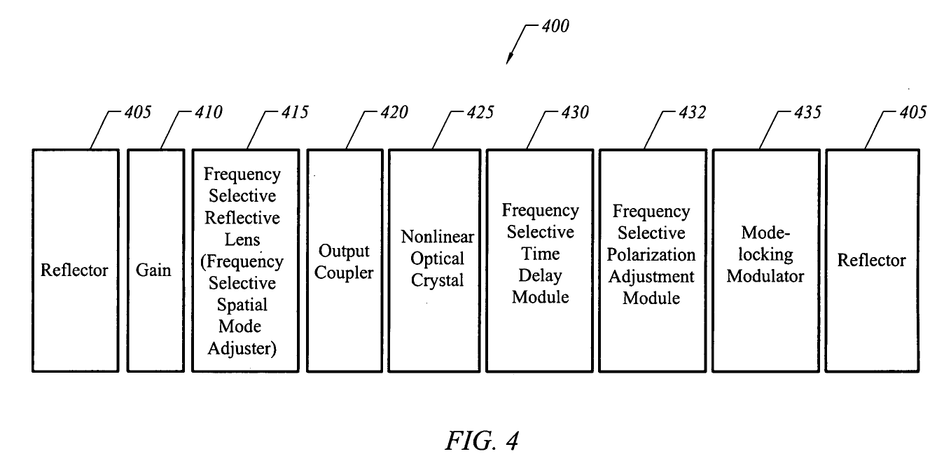

FIG. 4 is a block diagram illustrating a mode-locked laser system 400 in accordance with one embodiment of the present invention. Two or more reflectors 405 provide optical feedback for an optical resonator and may be arranged in a cavity or ring configuration. An optical gain element 410 provides optical gain about a fundamental frequency. The optical gain element 410 may comprise a solid-state, gas, liquid, or semiconductor laser gain medium.

Reflectors 405 and optical gain element 410 are selected to generate light at a fundamental frequency. Additional frequency selective elements (not shown) may be included to select a fundamental frequency of operation. An output coupler 420 is provided to extract at least a fraction of frequency converted light. A nonlinear optical material 425 is included to convert optical pulses at the fundamental frequency into frequency-shifted pulses at another frequency. In one embodiment nonlinear optical material 425 provides frequency doubling. More generally, however, nonlinear optical material 425 may perform any type of frequency conversion known in the art of optical frequency conversion, such as frequency tripling, quadrupling, or wavelength down conversion.

A mode-locking modulator 435 is used to generate mode-locked laser pulses at the fundamental frequency. A mode-locking modulator 435 may, for example, comprise a passive saturable absorber or an active modulator. In one implementation mode-locking modulator 435 is modulated at a harmonic or sub-harmonic of a cavity round-trip transit time.

In one embodiment laser system 400 is designed to permit optical pulses at the fundamental frequency to make two or more passes through nonlinear optical material 425. One or more features may be included to increase the efficiency with which additional frequency-shifted light is generated in additional passes through nonlinear optical material 425. A frequency selective time delay module 430 performs a time delay operation that temporally shifts the relative position of pulses at the fundamental frequency at least partially away from frequency-shifted pulses. In one embodiment a frequency selective beam-shaping element, such as a frequency selective reflective lens 415, is included to change the spatial profile of frequency shifted pulses with respect to pulses at the fundamental frequency. In one embodiment, a frequency selective polarization adjustment module 432 is included to change the polarization of frequency shifted pulses with respect to pulses at the fundamental frequency.

In accordance with the present invention, the frequency conversion process is improved by changing an attribute of the frequency-shifted pulses with respect to pulses at the fundamental frequency such that interference effects in the nonlinear optical material in subsequent passes of frequency conversion are reduced. In particular, it is desirable to achieve at least a partial reduction in the temporal, spatial, or polarization overlap of pulses at the fundamental frequency and the frequency-shifted pulse that are coupled back to nonlinear optical material 425 for a subsequent pass of frequency conversion. In other words, the overlap reduction may be done in the spatial, temporal, or polarization domains. The reduction in temporal, spatial, or polarization overlap reduces interference effects that degrade the efficiency with which the pulse at the fundamental frequency can generate additional frequency-shifted light in the second pass. As an illustrative example, consider an initial pulse of light generated at the fundamental frequency. In a first pass through nonlinear optical material 425 a portion of the pulse is converted into a pulse of frequency shifted light having approximately the same spatial profile, same polarization, and traveling in the same direction at the same time as the fundamental pulse. If these two pulses are then reflected back to the nonlinear optical material 425 for a second pass of frequency conversion there is a potential for interference effects which may degrade the efficiency of the frequency conversion process in the second pass. Nonlinear frequency conversions depend strongly upon the electric field and proper phase relationships. The frequency-shifted light generated in the first pass of frequency conversion thus has the potential to create electric fields that interfere with efficient frequency conversion in the second pass. These interference effects can be substantially eliminated by reducing the temporal, spatial, or polarization overlap of the two pulses using frequency selective time delay module 430, frequency selective reflective lens 415, or frequency selective polarization adjustment module 432.

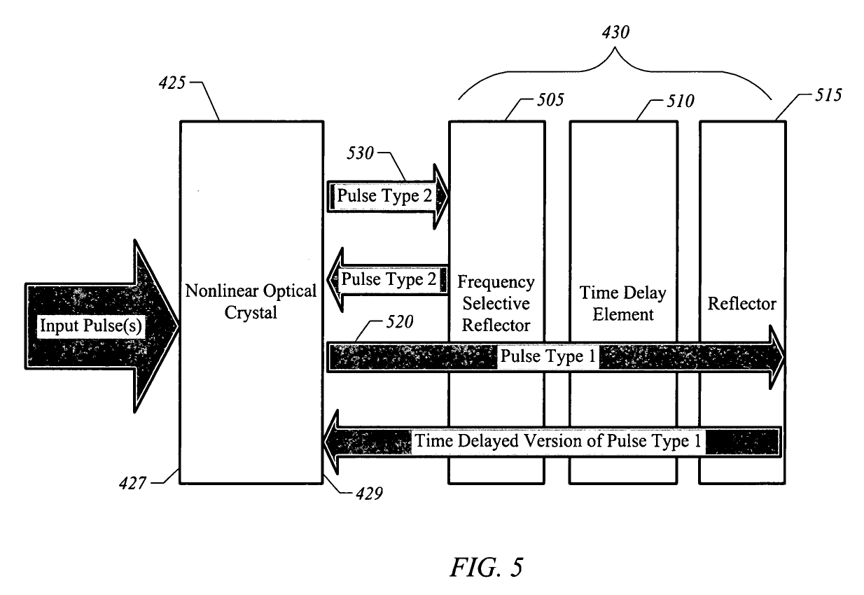

FIG. 5 illustrates the operation of the selective time delay module 430 in accordance with one embodiment of the present invention. Input pulse(s) enter a first facet 427 of nonlinear optical crystal 425. The nonlinear optical crystal 425 performs a frequency conversion operation, such as converting a portion of the input optical pulses to a frequency-shifted frequency. In one embodiment, nonlinear optical material performs frequency doubling, although more generally the conversion process may be any nonlinear optical frequency conversion operation known in the art of optics. Consequently, optical pulses of at least two different frequencies emerge from a second facet 429 of nonlinear optical crystal.

A frequency selective reflector 505 permits a first type of pulse 520 and a second type of pulse 530 centered at two different frequencies to be temporally separated. As one example, the first type of pulse 520 may be centered at a fundamental frequency and the second type 530 of pulse may be a frequency shifted pulse. For example, frequency selective reflector may be highly transmissive at one or more frequency bands and highly reflective at one or more frequency bands. As a result, only pulses at selected frequencies will enter time delay element 510 and be reflected back by reflector 515. Time delay element 5 10 may, for example, comprise a length of low-loss material. Thus, while both the first type and second type of pulses 520 and 530 are reflected back to the second facet 429 of nonlinear optical material 425, a time delay is introduced between the two types of reflected pulses that reduces their temporal overlap within nonlinear optical material 425. This reduces interference which would decrease the efficiency with which nonlinear frequency conversion occurs. In one embodiment the time delay is selected to achieve a complete temporal separation of reflected pulses of the first type 520 and the second type 530. However, it will be understood that more generally only a partial reduction in temporal overlap of reflected pulses is required to improve the efficiency of the nonlinear frequency conversion process.

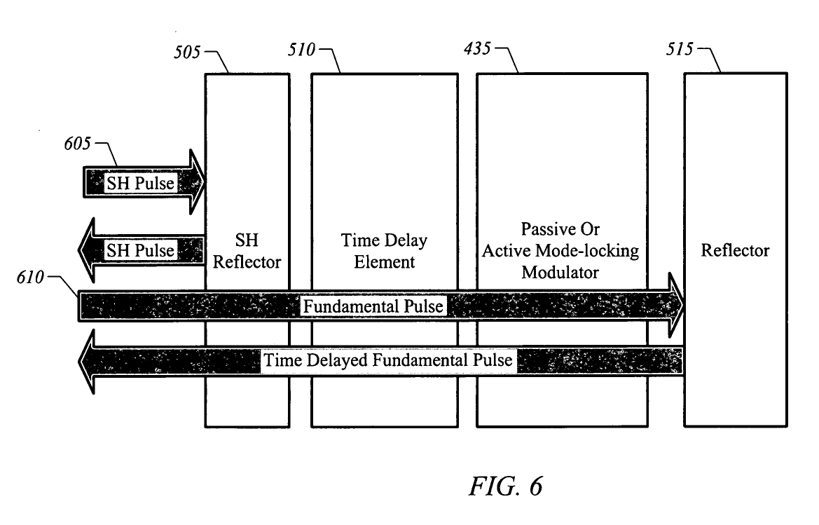

FIG. 6 illustrates an embodiment in which pulses at the fundamental frequency are selectively transmitted to a mode-locking modulator 435, thereby reducing insertion losses for frequency converted pulses 605. Frequency selective filter 505 selectively reflects frequency converted pulses (e.g., second harmonic pulses that have been frequency doubled). Pulses 610 at the fundamental frequency travel onwards to mode-locking modulator 505 and are then reflected back by reflector 515. As a result, only pulses at the fundamental frequency experience the insertion losses of the mode-locking modulator 435. The time delay element 510 may also be integrated in this configuration to delay the reflected fundamental pulses.

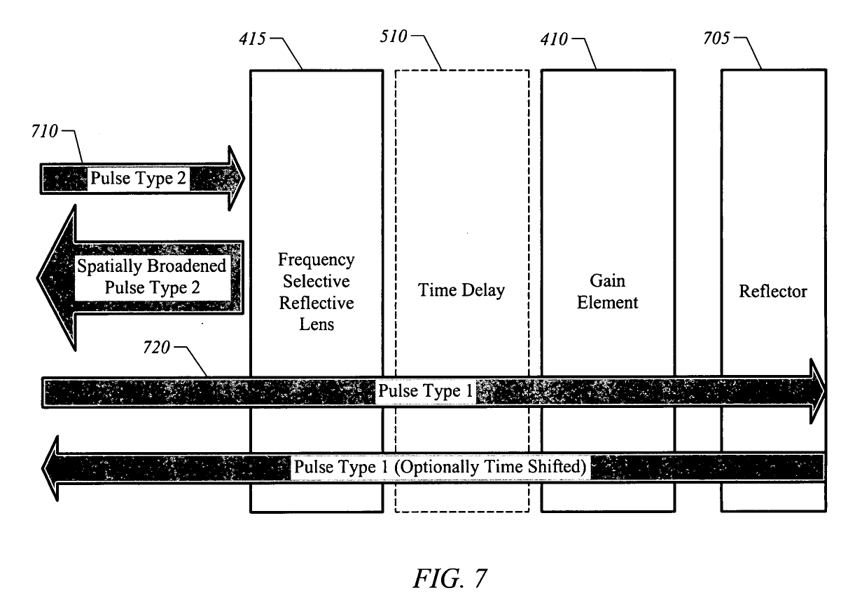

FIG. 7 illustrates an embodiment in which interference is reduced by using a frequency selective lens 415 to spatially broaden pulses of a second type 710 with respect to pulses of a first type 720 prior to reflection back towards a nonlinear optical crystal (not shown in FIG. 7). The frequency selective lens 415 is adapted to selectively transmit at least one band of frequencies, such as frequencies centered about pulse type 1. As a result, the first type of pulses is transmitted through frequency selected lens and is reflected back by reflector. Additional optical elements may be placed between frequency selective reflective lens 415 and reflector 705. For example, optical gain element 410 may be disposed between frequency selective reflective lens 415 and reflector 705. A time delay element 510 may be disposed between frequency selective reflective lens 415 and reflector 705. In one embodiment (not illustrated) a mode-locking modulator is also included between frequency selective reflective lens 415 and reflector 705.

One or more of the components of the mode-locked laser of the present invention may be implemented in semiconductor materials used in opto-electronic devices such as GaAlAs, GaAlAsP, GaInAsP, GaInNAs, strained InGaAs, GaInNAsSb, InP/InGaAsP/AlGaAs, and GaN. Additionally, two or more components may be integrated in a single semiconductor element. In particular, the mode-locked laser of the present invention may be implemented with a surface emitting laser structure based on semiconductor materials. The mode-locking modulator may, for example, be formed from a quantum well absorber whose absorption properties are controlled by an electric field to form a saturable absorber. A time delay element may be formed from a length of semiconductor material that has a low optical absorption for the frequency of light that is transmitted through the material. In one embodiment, Bragg mirrors are used to form one or more mirrors. In the case of a device in which the saturable absorbing delay structure is separate from the gain element, the Bragg mirror associated with this saturable absorber device is designed to be substantially 100% reflective at the fundamental wavelength while the surface facing the cavity is transparent at the fundamental laser wavelength and highly reflective at the harmonic wavelength. In another embodiment, two Bragg mirrors, may serve as an output coupler, either as a separate element or including quantum wells, such as GaInAs quantum wells, acting as the saturable absorbing material. In this case, the resonant bandwidth of this pair of mirrors would serve to control the operating wavelength as well as controlling the spectral width of the mode locked pulses.

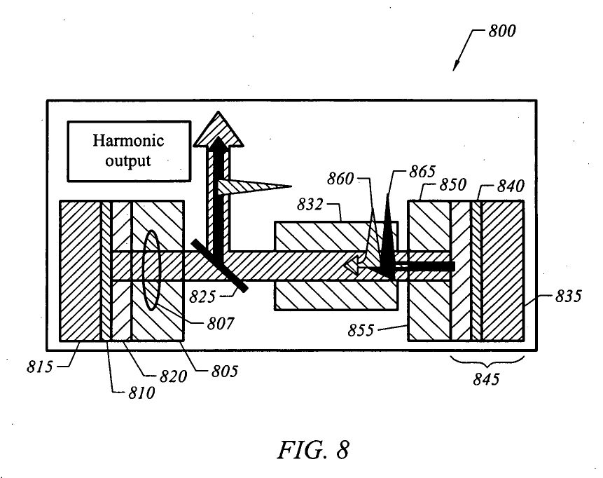

FIG. 8 is a diagram of an extended cavity surface emitting laser 800 of a mode-locked laser. For the purposes of illustrating the principles of the present invention, laser 800 is described as performing harmonic conversion (e.g., frequency doubling for second harmonic conversion) although it will be understood that it may be adapted to perform other types of nonlinear frequency conversion such that laser 800 may be adapted for use in generating, infrared, visible, or ultra-violet radiation. A surface emitting gain element 805 is located about a first end of the laser cavity and also forms one of the cavity mirrors of the laser. The surface emitting gain element 805 may, for example include a quantum well gain region 810 disposed between a first distributed Bragg reflector 815 and a second distributed Bragg reflector 820. Surface emitting gain element 805 generates optical gain about a fundamental frequency and forms one of the cavity mirrors. Surface emitting gain element 805 may, for example, be electrically, optically or electron beam-pumped. In one embodiment, a thermal lens 807 is formed in surface emitting gain element 805 to focus light. In one embodiment the gain region 810 is formed from semiconductors in the GaAlAs, GaInAs, GaAsP, or GaInAsP materials system depending upon the fundamental frequency of the laser.

An output coupler 825 is provided that is highly transmissive at the fundamental wavelength and highly reflective at the harmonic frequency. That is, output coupler 825 generates a comparatively high loss for light at the harmonic and a comparatively low loss for light at the fundamental frequency. In one embodiment output coupler 825 is a reflective filter oriented at an angle, typically 45 degrees as a convenience, to the path of the laser light. This component can serve to both polarize the fundamental wavelength and act as the output coupler for the harmonic radiation. In an alternate embodiment two dichroic beam-splitters contained within the cavity on either side of the nonlinear optical material 832 may be used to extract the harmonic radiation, but in two separate beams.

A nonlinear optical material 832 (e.g., a nonlinear crystal) is provided for generating harmonic pulses Examples of nonlinear materials include periodically poled crystals of lithium niobate, KTP, lithium tantalate, potassium niobate and un-poled bulk materials such as lithium niobate, BBO, LBO, KTP or waveguides formed from such materials.

A semiconductor element 835 is located about a second end of the laser cavity and may also form a second mirror of the laser cavity. In one embodiment semiconductor element 835 includes a saturable absorber 840. In one embodiment, a saturable absorber 840 is fabricated from quantum wells in the GaInAs, GaAsP, GaAlAs, GaInAsP, GaInNAs or GaN materials system depending upon the fundamental frequency of the laser. An optical coating 855 is formed on an entrance surface of semiconductor element 835 that is highly transmissive at the fundamental frequency and highly reflective at the harmonic frequency. A length of material 850 is included to generate a pre-selected time delay. In one embodiment Bragg reflectors 845 are used to form the second mirror of the cavity. This cavity mirror is preferably nominally 100% reflecting at the fundamental wavelength. In the case of a GaInAs laser, as an example, the cavity mirror would be comprised of alternating quarter wavelength layers of GaAl₁₋ₓAsₓ/GaAl_{1-y}As_{y} to form 100% reflective Bragg mirrors 845 formed proximate saturable absorber 840. In one embodiment the Bragg mirrors 845 are doped to form a p-n junction about saturable absorber 840 such that an electric field may be applied to saturable absorber 840.

As an illustrative example, consider an initial pulse of light at the fundamental frequency traveling in a direction from surface emitting gain element 805 towards semiconductor element 835. Nonlinear crystal 832 will convert a portion of the fundamental pulse into a pulse at the harmonic frequency, both pulses reaching optical coating 855 of semiconductor element 835. The pulse at the harmonic frequency is reflected from the surface of optical coating 855. The pulse at the fundamental frequency travels into semiconductor element 835. A time delay is introduced by the transit time of material 840. As a result, when the fundamental pulse emerges from semiconductor element 835 it is temporally separated from the harmonic pulse. As illustrated in FIG. 8, the temporal separation is preferably such that a pulse 860 at the harmonic frequency does not overlap with the fundamental pulse 865 within nonlinear material 832. Thus, the fundamental and harmonic beams travel in the same laser cavity beam path, but time delayed with respect to one another as they travel back through the nonlinear material. The un-depleted portion of the returning fundamental beam traveling back through the non-linear crystal can be further efficiently converted to the second harmonic, thereby increasing the efficiency of total conversion.

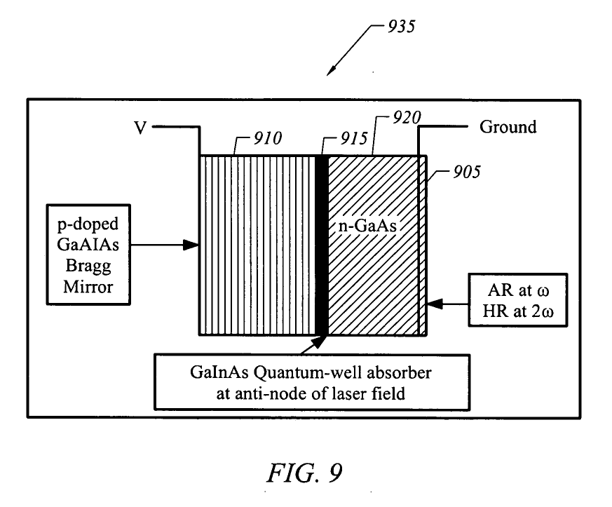

FIG. 9 illustrates an exemplary implementation of a semiconductor element 935 for performing mode-locking and time shifting. An optical coating 905 is provided that is highly reflective (HR) at the harmonic frequency and anti-reflective (AR) at the fundamental frequency. A Bragg mirror 910 is formed from doped GaAlAs layers. A GaInAs quantum well region 915 acts as a saturable absorber. The saturable absorber is placed to interact with the laser field and may, for example, be located at one or more anti-nodes of the laser field. A doped GaAs region 920 may be included as a time delay element and also have a sufficient doping to serve as part of p-n junction. As an illustrative example, the thickness of GaAs region 920 may correspond to 100 microns of GaAs. The structure shown in FIG. 9 has a p-n junction that can be reverse biased to tune the absorption of quantum well region 915 into the appropriate energy range to optimize the saturable absorption process. In addition, this bias voltage can be modulated to modulate the laser as well as to mode-lock the device. In particular, the saturable absorber is preferably designed to permit modulation at a rate comparable to the laser cavity response time. The current generated in the reversed-bias junction can also be used to monitor the power of the mode-locked laser. In one embodiment a voltage applied to the saturable absorber by the p-n junction is modulated at a harmonic or sub-harmonic of the cavity round-trip transit time. For example, a signal may selected from the fundamental laser output and feed back through a narrow-band electronic amplifier tuned to the harmonic or sub-harmonic of the round-trip cavity transit time.

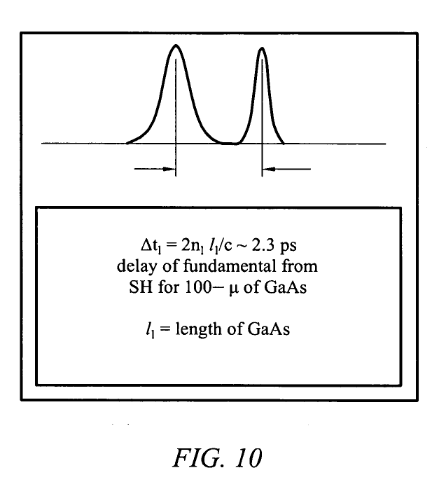

FIG. 10 illustrates a calculation of the time delay between the fundamental frequency pulse and the second harmonic pulse for the embodiment of FIG. 9. In this example, the GaAs has a thickness of 100 microns. The time delay may be calculated from first principals from the path length and the velocity of light in GaAs. The delay time, Δt₁=2n₁1/c, where n, is the refractive index in GaAs, 1₁ is the length of the GaAs material, and c is the velocity of light in free space. For a 100 micron thick GaAs region the time delay is about 2.3 picoseconds. This time delay is greater than the pulse width in many extended cavity laser designs. For a particular application, the spectral width of the mode-locked pulses may be determined by modeling or empirical measurements for a particular cavity length. The length of the thickness of material required to temporally shift pulses at the fundamental and harmonic frequencies may then be selected to achieve a sufficient time delay to improve efficiency while also achieving a reasonable optical loss for the fundamental frequency.

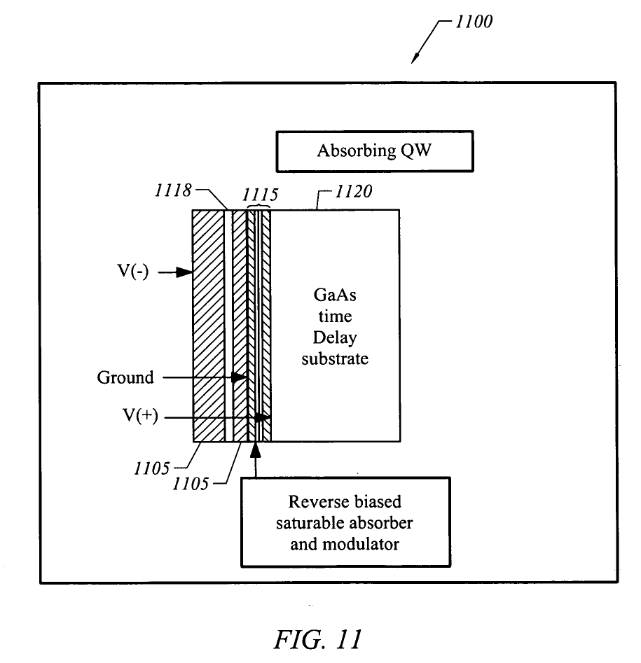

FIG. 11 illustrates an embodiment in which a surface emitting gain element 1100 includes Bragg reflectors 1105, a quantum well gain region 1118, a saturable absorber 1115 formed from quantum wells disposed within a p-n junction, and a thickness of GaAs selected to form a time delay region 1120. When the surface emitting laser gain element has a thick GaAs substrate acting as one of the electrical conduction paths as shown in FIG. 11 the additional path for the fundamental mode-locked pulse will delay this pulse with respect to the second harmonic pulse. In this embodiment of the gain structure, the GaAs substrate is typically 50-100 microns thick, while the diameter of the active region can be several tens to hundreds of microns. This GaAs substrate is contained in the laser cavity while the quantum well gain region is clad by a nominally 100% reflective p-mirror on the bottom and a less than 100% reflective n-mirror. Alternatively, the device may also operate without the n-Bragg mirror. The top surface of the GaAs in the region not covered by the optical aperture is coated to be highly transmissive at the fundamental wavelength and highly reflective at the second harmonic wavelength.

Note that the thickness of the GaAs substrate 1120 affects the transverse mode and the effective optical length. Thus, in some cases there are other optical reasons to further increase the thickness of GaAs substrate 1120 beyond the minimum thickness needed to achieve a time delay for separating optical pulses, e.g., to a thickness greater than several hundred microns. In some embodiments of this invention, it may be advantageous to use a thicker GaAs substrate or bond GaAs or some other high-refractive index material to the substrate. For example, it may be desirable for some applications to replace 1 mm of air space by a GaAs spacer. The physical length of GaAs required to maintain the same transverse mode as 1 mm of air space is given by n_{GaAs}Lₐᵢᵣ˜3.5 mm, where n_{GaAS} is the refractive index of GaAs (i.e., 3.5) and L is the air thickness (i.e., 1 mm). At the same time, 3.5 mm of GaAs defines the effective optical length of n_{GaAs}L_{GaAs}˜12.25 mm. Thus, by replacing a segment of air with GaAs, it is possible to get an approximately twelve-fold increase in the effective optical cavity length in that segment. This increase may be advantageous in designing the lasers with lower repetition rates and higher power levels.

In the case where the saturable absorber is fabricated as part of surface emitting gain element 1100, a simple linear cavity would suffice. The backward traveling second harmonic radiation would be reflected off the surface of the chip in a co-linear fashion with respect to the forward going wave. The spatial positions of the absorbing quantum-wells are at or near the peak of the laser standing wave.

In one embodiment the saturable absorber 1115 is made of GaInAs in the case of a GaInAs quantum well laser device. The absorption is adjusted by reverse biasing of the structure to tune the optical band-gap of the absorbing quantum wells. Background information on saturable absorption of quantum wells are described in the papers “Characteristics of high-speed passively mode-locked surface emitting semiconductor InGaAs laser diode”, by Qiang Zhang, Khalil Jasmin, A. V. Nurmikko, Erich Ippen, Glen Carey and Wanill Ha, Electronics Letters, volume 17, pages 525-527, March, 2005 and “Extended-cavity surface emitting diode laser as active mirror controlling mode-locked Ti:sapphire laser”, by B. Stormont, E. U. Rafailov, I. G. Cormack and Wilson Sibbett, in Electronics Letters, 10 June 2004, Vol. 40, No. 12, pages 732-734, the contents of each of which are hereby incorporated by reference.

In addition, the saturable absorber 1115 is preferably designed to be modulated at high speed, limited only by the laser cavity response time, by changing the applied reverse bias voltage to the saturable absorbing structure. This response time would typically be less than one nano-second for a one cm long cavity.

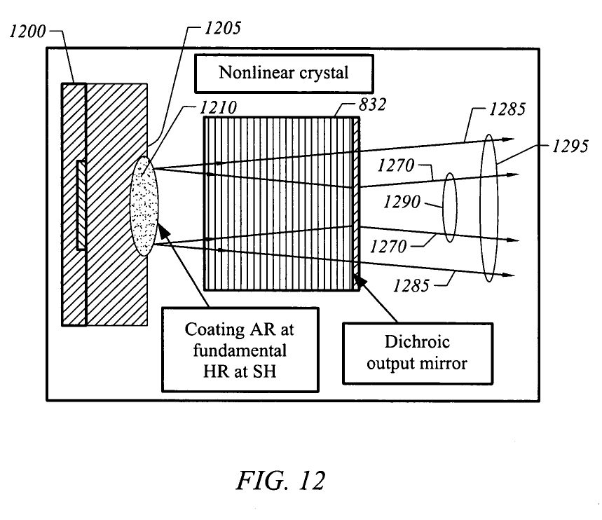

FIG. 12 illustrates an embodiment in which a surface emitting gain element 1200 includes a lens 1205. An optical coating 1210 is disposed in front of lens 1205. Optical coating 1210 is highly transmissive to the fundamental frequency and highly reflective at the harmonic frequency. The optical properties of lens 1205 can be selected to achieve a significant difference in spatial profile of optical pulses at the harmonic and fundamental frequencies in nonlinear crystal 832. As illustrated by outline lines 1285, the harmonic mode 1295 may, for example diverge with respect to the mode 1290 at the fundamental frequency, as indicated by outline lines 1270. As a result the two modes 1290 and 1295 have different mode profiles within nonlinear crystal 832. In particular the mode of the second harmonic 1295 is spread out such that it has a reduced electric field within nonlinear crystal 832. As a result, interference with the frequency conversion process is reduced.

Lens 1205 may be an internal thermal lens or a separate optical element. For example, there can be a lens in the cavity to form a stable cavity mode. Alternatively, a thermal lens formed within the gain element structure can also be used to stabilize the cavity or a lens may be etched directly on the GaAs substrate by techniques known in the literature. In the case of an internal thermal lens, the optical surface on the gain element is flat and the second harmonic reflected from coating 1210 continues to slightly diverge while optical pulses at the fundamental frequency that emerge from surface emitting gain element 1200 converge. Note that in some implementations lens 1205 acts as a convex mirror for harmonic light. For implementations in which lens 1205 is not flat (e.g., a separate optical element or an etched cavity lens) lens 1205 will typically bulge out and by virtue of the optical coating 1210 that is reflective for the harmonic frequency form a convex mirror for light at the harmonic frequency. The convex mirror will also increase the divergence of the harmonic pulse. In this way, the intensity of the second harmonic wave can be significantly reduced to minimize the interference between the two beams while still maintaining the co-linearity of the beams.

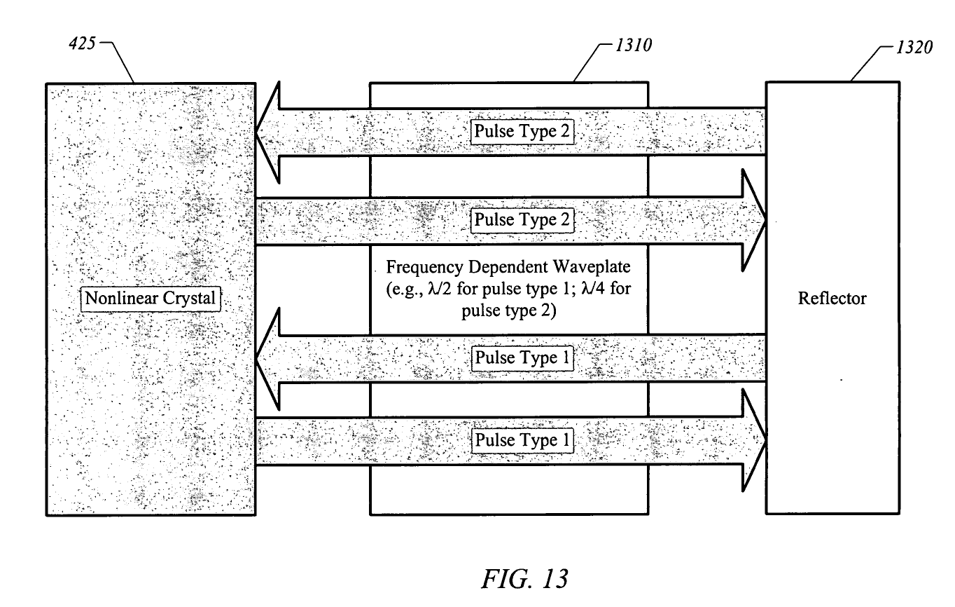

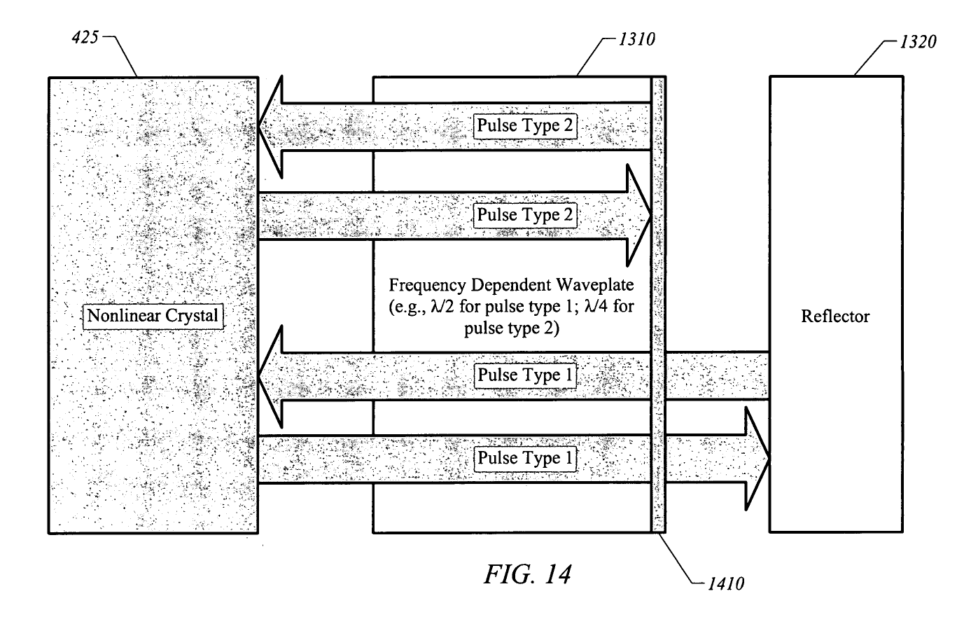

FIG. 13 illustrates an embodiment in which the polarization of the pulse at the fundamental frequency and the polarization of the pulse at a frequency-shifted frequency are rotated with respect to each other to achieve at least a partial reduction in polarization overlap. As previously described, when a pulse at the fundamental frequency generates frequency-shifted light in nonlinear crystal 425, the frequency shifted light generated by the frequency conversion process will emerge from nonlinear crystal 425 with the same initial polarization as the fundamental frequency. A frequency dependent waveplate 1310 is included in the laser resonator which rotates the polarization of pulses at the fundamental frequency by a different amount per pass than frequency-shifted pulses. For example, waveplate 1310 may be designed to operate as a half-wave plate at the fundamental frequency and a quarter wave plate at the harmonic frequency. Reflection off of a reflector 1320 results in the two pulses making two passes through waveplate 1310. After two passes through a half-wave plate the polarization state of pulses at the fundamental frequency returns to its original value. However, after two passes through a quarter-wave plate, pulses at the harmonic frequency have their polarization rotated ninety degrees out of phase. FIG. 14 shows an alternate embodiment, similar to FIG. 13 except that waveplate 1310 further includes an optical coating 1410 disposed on a surface of waveplate 1310 that is reflective at the frequency-shifted frequency but transparent to the fundamental frequency. This forces the frequency-shifted light to make two passes through waveplate 1310 while permitting pulses at the fundamental frequency to travel onwards to other optical elements within the optical resonator.

Frequency dependent waveplates are available from a variety of different vendors. Such waveplates are often known as “dual-wavelength wave plates.” For example, CVI Laser of Albuquerque, N. Mex. sells dual-wavelength waveplates. Other vendors of dual-wavelength waveplates include the Casix company, which was acquired by Fabrinet of San Francisco, Calif.

It will be understood that many variations of the present invention are within the scope of the present invention. In one embodiment a surface emitting gain element with an integrated mode-locking modulator may be utilized as part of a laser system that does not perform intra-cavity frequency conversion. In this embodiment, the frequency conversion process is performed externally to the laser cavity and the nonlinear material replaced with a linear material as an intra-cavity dielectric spacer to maintain other optical characteristics of the mode-locked laser. This linear material may be an extended GaAs spacer, an optical glass, or an optical element with desirable wavelength-dependent or wavelength-independent transmission. An example of an optical element with a wavelength-dependent transmission is a volume grating which can be useful is selecting the wavelength for external frequency conversion. In the preferred embodiment, the laser chip, the saturable absorber, and a dielectric spacer are monolithically bonded or arranged on a substantially planar platform in a low-cost package. The nonlinear material or materials used for the frequency conversion, and possibly, focusing optics, are positioned externally to the laser cavity. In embodiments that do not feature intra-cavity frequency conversion the time delay elements may be omitted.

In one embodiment the nonlinear crystal is also used to provide polarization control. Details of extended cavity surface emitting lasers in which nonlinear crystals are used to provide polarization control are described in U.S. patent application Ser. Nos. 10/745,342 and 10/734,553, the contents of which are hereby incorporated by reference.

Mode-locked lasers of the present invention may be adapted to include additional features to facilitate high peak pulse power operation. In one embodiment a cavity dumper is included in the resonator to extract optical pulses. In one embodiment the mode-locked laser is operated in a gain-switched mode. The semiconductor gain medium may also be pulsed.

As previously described the saturable absorber may be pumped at a repetition rate equal to the mode-locking round-trip time and harmonics or sub-harmonics of the same. In addition to electrical pumping, the saturable absorber may also be optically pumped. Additionally, the gain element may be modulated at a harmonic or a sub-harmonic of the cavity round-trip time.

The mode-locked lasers of the present invention may be used in a variety of applications. In one application, the mode-locked surface emitting lasers are used as a light source for a projection display. Mode-locking increases spectral bandwidth, which is beneficial for reducing speckle in a projection display system. Mode-locking is also beneficial to increase peak output power.

In one embodiment, the mode-locked lasers are designed to be fabricated as one or two-dimensional arrays such that an individual semiconductor die includes components for a plurality of lasers. For example, in the embodiment of FIG. 11 gain elements, modulators, and time delay elements may be formed on a substrate for an array of lasers. The array of lasers may share a number of optical elements in common. For example, a common nonlinear crystal may be used for an array of lasers. In a preferred embodiment arrays of lasers are packaged as a monolithic assembly of a laser chip, a saturable absorber, and a transparent dispersive material spacer. The infrared output beam of such a mode-locked laser can also be frequency doubled with a nonlinear crystal outside the laser cavity. In one embodiment the arrays of lasers are operated incoherently with respect to each other. For example, each laser in the array may be independently addressable.

Another application is to provide a light source for optical lighting applications. Mode-locked surface emitting lasers are capable of providing high power light for applications that would conventionally use other light sources. For example, an array of mode-locked lasers may be coupled to an optical guide to provide a source of high power visible light at one or more different colors. This has potential applications in a variety of lighting applications where conventionally comparatively inefficient and complicated optical sources (e.g., neon lights) would be used.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. An apparatus for improving the efficiency of a mode-locked laser having multi-pass optical frequency conversion, comprising:
a time delay element for delaying the transmission of optical pulses;
an entrance to said time delay element configured to be transmissive to optical pulses at a fundamental frequency of said mode-locked laser and reflective at a second frequency; and
an end reflector for reflecting light at said fundamental frequency back towards said entrance;
wherein said time delay element introduces a time delay between optical pulses at said fundamental frequency emerging from said entrance and optical pulses at said second frequency reflected from said entrance whereby interference effects in a subsequent nonlinear optical material used to generate light at said second frequency are reduced.

2. The apparatus of claim 1, further comprising: an optical gain region for generating gain at said fundamental frequency.

3. The apparatus of claim 1, wherein said time delay element comprises a length of semiconductor material have a low optical loss for light at said fundamental frequency and introduces a time delay corresponding to at least a portion of the spectral bandwidth of optical pulses in said mode-locked laser whereby optical pulses at said fundamental frequency are at least partially temporally separated from optical pulses at said second frequency.

4. The apparatus of claim 1, wherein said entrance includes an optical coating that is transmissive to said fundamental frequency and reflective to said second frequency.

5. The apparatus of claim 1, further comprising a lens selected such that reflected light at said second frequency is defocused with respect to light emerging from said entrance at said fundamental frequency.

6. The apparatus of claim 1, wherein said mode-locked laser modulator comprises a saturable quantum well absorber.

7. The apparatus of claim 1, wherein said end reflector comprises a Bragg reflector formed in a semiconductor element.

8. The apparatus of claim 1, further comprising a mode-locked laser modulator.

9. A semiconductor element for improving the efficiency of a mode-locked laser having multi-pass intra-cavity frequency doubling, comprising:
a time delay element formed from a first region of said semiconductor element for delaying the transmission of optical pulses;
an optical coating formed on a front surface of said semiconductor element configured to be transmissive to optical pulses at a fundamental frequency of said mode-locked laser and reflective at a harmonic frequency;
a quantum well saturable absorber formed in a second region of said semiconductor element;
an end reflector formed in a third region of said semiconductor element for reflecting light at said fundamental frequency back towards said optical entrance;
wherein said time delay element introduces a time delay between optical pulses at said fundamental frequency and optical pulses at said harmonic frequency directed towards a nonlinear optical material whereby interference effects in said nonlinear optical material are reduced.

10. The apparatus of claim 9, further comprising: an optical gain region disposed in a fourth region of said semiconductor element for generating gain at said fundamental frequency.

11. The apparatus of claim 9, further comprising a lens formed in said semiconductor element such that reflected light at said harmonic frequency is defocused with respect to light emerging from said entrance at said fundamental frequency.

12. A method of operating a mode-locked laser, comprising:
providing a nonlinear material within an optical resonator for frequency conversion of optical pulses at a fundamental frequency;
generating mode-locked laser pulses at said fundamental frequency within said optical resonator;
in a first pass through said nonlinear material, generating an optical pulse at a harmonic frequency to form a first pulse at a harmonic frequency;
time delaying a partially depleted optical pulse at said fundamental frequency output received from said nonlinear material to generate a time delayed fundamental pulse; and
coupling said first pulse at said harmonic frequency and said time delayed fundamental pulse back to said nonlinear material to generate a second pulse at said harmonic frequency.

13. A mode-locked laser, comprising:
an optical resonator;
a laser gain element disposed in said optical resonator for providing optical gain about a fundamental laser frequency;
a mode-locking modulator disposed in said optical resonator;
a nonlinear optical material disposed in said optical resonator for performing optical frequency conversion in which an input pulse at said fundamental laser frequency is converted into an output pulse of reduced power at said fundamental laser frequency and an output optical pulse at a harmonic frequency; and
a frequency selective time delay element disposed in said optical resonator, said frequency selective time delay element introducing a time delay between optical pulses at said fundamental laser frequency and optical pulses at said second harmonic wavelength whereby interference between optical pulses at said harmonic frequency and said fundamental frequency in said nonlinear optical material is reduced.

14. The laser of claim 13, wherein said mode-locking modulator comprises a saturable absorber.

15. The laser of claim 14 where the saturable absorber comprises quantum wells selected from the group of materials consisting of GaInAs, GaAsP, GaAlAs, and GaInAsP.

16. The laser of claim 14 in which said saturable absorber is grown adjacent to a highly reflective semiconductor Bragg mirror made up of alternate layers of GaAlAs and GaAs that serve as one of the mirrors in the laser resonator.

17. The laser of claim 13 in which the laser gain element is selected from the group of semiconductor laser materials consisting of GaAlAs, GaInAs, GaAsP, and GaInAsP.

18. The laser of claim 13 in which the saturable absorber is grown on a semiconductor substrate adjacent to a gain media forming said gain element.

19. The laser of claim 13 in which said saturable absorber comprises at least one quantum well disposed in a p-n semiconductor junction for applying a reverse bias voltage to said at least one quantum well to adjust optical loss of said saturable absorber.

20. The laser of claim 13 in which the voltage applied to the saturable absorber can turn the laser off and on to produce a modulated train of mode-locked pulses at the fundamental and the second harmonic.

21. The laser of claim 19 in which the current of said saturable absorber is used to monitor the laser power.

22. The laser of claim 13 in which the laser gain medium is selected from the group consisting of solid-state, gas, semiconductor, and liquid laser medium.

23. The laser of claim 13 in which the nonlinear material is selected from the group consisting of poled lithium niobate, poled KTP, poled lithium tantalate, poled potassium niobate, un-poled bulk lithium niobate, unpoled bulk BBO, unpoled LBO, and unpoled KTP.

24. The laser of claim 13 in which the nonlinear conversion is selected from the group of frequency conversion processes consisting of frequency doubling, frequency tripling, frequency quadrupling, and wavelength down-conversion.

25. The laser of claim 13 in which there are a multiple of devices arranged in a one- or two-dimensional array in which the devices are independently addressable.

26. An extended cavity semiconductor laser, comprising:
a surface emitting semiconductor element including:
a quantum well gain region; and
an integrated quantum well saturable absorber for providing mode-locking;
at least one Bragg reflector; and
an external mirror.

27. A mode-locked laser, comprising:
an optical resonator;
a laser gain element disposed in said optical resonator for providing optical gain about a fundamental laser frequency;
a mode-locking modulator disposed in said optical resonator;
a nonlinear optical material disposed in said optical resonator for performing optical frequency conversion in which an input pulse at said fundamental laser frequency is converted into an output pulse of reduced power at said fundamental laser frequency and an output optical pulse at a harmonic frequency; and
an element disposed in said optical resonator configured to at least partially reduce the spatial, temporal, or polarization overlap of output optical pulses at said harmonic frequency with optical pulses at said harmonic frequency whereby interference between optical pulses at said harmonic frequency and said fundamental frequency in said nonlinear optical material are reduced.

28. A method of operating a mode-locked laser, comprising:
providing a nonlinear optical material within an optical resonator for frequency conversion of optical pulses at a fundamental frequency;
generating mode-locked laser pulses at said fundamental frequency within said optical resonator;
in a first pass through said nonlinear optical material, generating an optical pulse at a harmonic frequency to form a first pulse at a harmonic frequency and a second optical pulse at said fundamental frequency; and
at least partially reducing a temporal, spatial, or polarization overlap of said first pulse and said second pulse prior to coupling said first pulse and said second pulse back to said nonlinear optical material, whereby interference effects are reduced in said nonlinear optical material.
